(19) United States
(12) Patent Application Publication
(10) Pub. No.: US 2011/0304911 A1
(43) Pub. Date: Dec. 15, 2011

(54) STEREOSCOPIC DISPLAY SYSTEM

(75) Inventors: Ta-Ming CHI, Oakland, CA (US); John-Ching SHIEH, Taipei (TW)

(73) Assignees: John-Ching Shieh, Taipei (TW); Ta-Ming Chi, Oakland, CA (US)

(21) Appl. No.: 12/815,433

(22) Filed: Jun. 15, 2010

(51) Int. Cl. G02B 27/24

(52) U.S. Cl. 359/471

(57) ABSTRACT

A stereoscopic display system includes two displays and two beam splitters. A first display and a second display are for providing respective left eye and right eye images. A first beam splitter is inclined at 45 degree to the first display and a second beam splitter is inclined at 45 degree to the second display for directing the left eye and right eye images towards a viewer.

### BACKGROUND

1. Field of Invention

The present invention relates to a stereoscopic display system.

2. Description of Related Art

Presently three-dimensional displays are based either on imaging techniques which give rise to an apparent stereo by perspective views or on two images being presented which are separated such that the right eye and left eye see their respective images which are distinguished or differentiated by polarization characteristics of light. Most of these displays are single purpose in that they are designed for the purpose of viewing stereo. Two images separated or distinguished by polarization can either be superimposed as they are with two movie projectors or they may be displayed time sequentially to give an image which appears to be continuous.

Now, most of the major TV manufactures have opted to go with active-shutter TV sets, in part because they don't required polarizing filters on the TV screens themselves, and also because it is an easier way to deliver full 1080p resolution in a televised 3D format. The battery-powered, active-shutter glasses may be a good option for a viewer, except that they are a little bit expensive. There is a need to provide other economical options of a stereoscopic display system for the users.

### SUMMARY

In an aspect of this invention, a stereoscopic display system includes two displays and two beam splitters. A first display and a second display are disposed substantially along a straight line for providing respective left eye and right eye images. A first beam splitter is inclined at 45 degree to the first display for reflecting either one of the left eye and right eye images towards a viewer. A second beam splitter is inclined at 45 degree to the second display for reflecting the other one of the left eye and right eye images towards the viewer through the first beam splitter. The first beam splitter is in substantial parallel with the second beam splitter.

In another aspect of this invention, a stereoscopic display system includes two displays and two beam splitters. A first display and a second display are disposed substantially perpendicular to each other for providing respective left eye and right eye images. A first beam splitter is inclined at 45 degree to the first display and connected to an intersection of the first and second displays. A second beam splitter is inclined at 45 degree to the second display. Either one of the left eye and right eye images is serially reflected by the first and second beam splitters before reaching a viewer. The other one of the left eye and right eye images is passed through the first beam splitter and reflected by the second beam splitter before reaching the viewer.

In another aspect of this invention, a stereoscopic display system includes two displays and two beam splitters. A first display and a second display are disposed in substantial parallel with each other for providing respective left eye and right eye images. A first beam splitter is inclined at 45 degree to the first display and interconnected between the first and second displays. A second beam splitter is inclined at 45 degree to the second display and disposed substantially perpendicular to the first beam splitter. Either one of the left eye and right eye images is serially reflected by the first and second beam splitters before reaching a viewer. The other one of the left eye and right eye images is passed through the second beam splitter before reaching the viewer.

In still another aspect of this invention, a stereoscopic display system includes a plurality of display units interconnected to form a convex regular polygon for providing images to viewers around the convex regular polygon. Each display unit includes two displays and two beam splitters. A first display and a second display are for providing respective left eye and right eye images. A first beam splitter is inclined at 45 degree to the first display and a second beam splitter is inclined at 45 degree to the second display for directing the left eye and right eye images towards a viewer.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a side view of a stereoscopic display system according to a first embodiment of this invention;

FIG. 2 illustrates a side view of a stereoscopic display system according to a second embodiment of this invention;

FIG. 3 illustrates a side view of a stereoscopic display system according to a third embodiment of this invention;

FIG. 4 illustrates a side view of a stereoscopic display system according to a fourth embodiment of this invention;

FIG. 5 illustrates a side view of a stereoscopic display system according to a fifth embodiment of this invention;

FIG. 6 illustrates a side view of a stereoscopic display system according to a sixth embodiment of this invention;

FIG. 7 illustrates a side view of a stereoscopic display system according to a seventh embodiment of this invention;

FIG. 8 illustrates a side view of a stereoscopic display system according to an eighth embodiment of this invention;

FIG. 9 illustrates an embodiment of the display two displays L_{H}, L_{V} as illustrated in FIG. 1-FIG. 8;

FIG. 10 illustrates another embodiment of the display two displays L_{H}, L_{V} as illustrated in FIG. 1-FIG. 8; and

FIG. 11 illustrates a top view of a stereoscopic display system including multiple display units.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

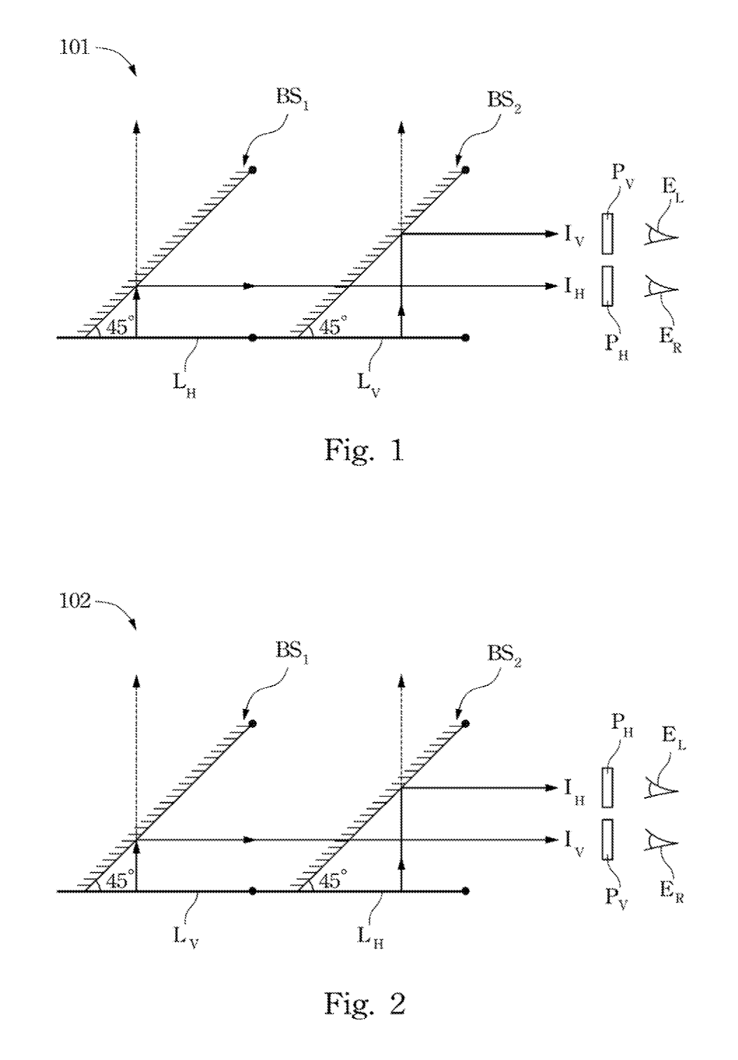

FIG. 1 illustrates a side view of a stereoscopic display system according to a first embodiment of this invention. The stereoscopic display system 101 basically includes two displays L_{H}, L_{V} and two beam splitters BS₁, BS₂. The two displays L_{H}, L_{V} respectively emit the right eye and left eye images, e.g. the display L_{H} emits the right eye image while the display L_{V} emits the left eye image, or the display L_{V} emits the right eye image while the display L_{H} emits the left eye image. The two displays L_{H}, L_{V} are arranged substantially along a straight line and may be arranged adjacent to each other. The beam splitter BS₁ is inclined at 45 degree to the display L_{H} for reflecting an image I_{H} from the display L_{H} towards a viewer's eyes E_{L}, E_{R} through the beam splitter BS₂. The beam splitter BS₂ is inclined at 45 degree to the display Lᵥ for reflecting an image I_{V} from the display L_{V} towards a viewer's eyes E_{L}, E_{R}. The viewer, who wears polarized 3D glasses P_{V}, P_{H} (one lens P_{V} is vertically polarized and the other one P_{H} is horizontally polarized), should be able to see a virtual right eye image in the right eye E_{R} and a virtual left eye image in the left eye E_{L}. The viewer's brain then receives the two different images and composites them into a virtual three-dimensional image.

FIG. 2 illustrates a side view of a stereoscopic display system according to a second embodiment of this invention. The stereoscopic display system 102 is almost the same as the stereoscopic display system 101 except that the two displays L_{H}, L_{V} in the stereoscopic display system 102 are arranged in reverse positions relative to the stereoscopic display system 101. The beam splitter BS₁ is for reflecting an image I_{V} from the display L_{V} towards a viewer's eyes E_{L}, E_{R} through the beam splitter BS₂. The beam splitter BS₂ is for reflecting an image I_{H} from the display L_{H} towards a viewer's eyes E_{L}, E_{R}.

FIG. 3 illustrates a side view of a stereoscopic display system according to a third embodiment of this invention. The stereoscopic display system 103 basically includes two displays L_{H}, L_{V} and two beam splitters BS₁, BS₂. The two displays L_{H}, L_{V} respectively emit the right eye and left eye images, e.g. the display L_{H} emits the right eye image while the display L_{V} emits the left eye image, or the display L_{V} emits the right eye image while the display L_{H} emits the left eye image. The two displays L_{H}, L_{V} are arranged substantially perpendicular to each other. The beam splitter BS₁ is inclined at 45 degree to the display L_{H} and connected to an intersection of the two displays L_{H}, L_{V}. The beam splitter BS₂ is inclined at 45 degree to the display Lᵥ and connected to an end of the display L_{V}, which is opposite to the intersection of the two displays L_{H}, L_{V}. Besides, the beam splitter BS₁ is in substantial parallel with the beam splitter BS₂. The image I_{V} is serially reflected by the beam splitter BS₁ and beam splitter BS₂ before reaching a viewer's eyes E_{L}, E_{R}. The image I_{H} is passed through the beam splitter BS₁ and reflected by the beam splitter BS₂ before reaching the viewer's eyes E_{L}, E_{R}. Since the images I_{H} and I_{V} are reflected by different times, e.g. one time and two times, before reaching the viewer's eyes E_{L}, E_{R}, either the display L_{V} or L_{H} has to be reversed in displaying the image left to right, thereby providing a correct composite image. The viewer, who wears polarized 3D glasses P_{V}, P_{H} (one lens P_{V} is vertically polarized and the other one P_{H} is horizontally polarized), should be able to see a virtual right eye image in the right eye E_{R} and a virtual left eye image in the left eye E_{L}. The viewer's brain then receives the two different images and composites them into a virtual three-dimensional image.

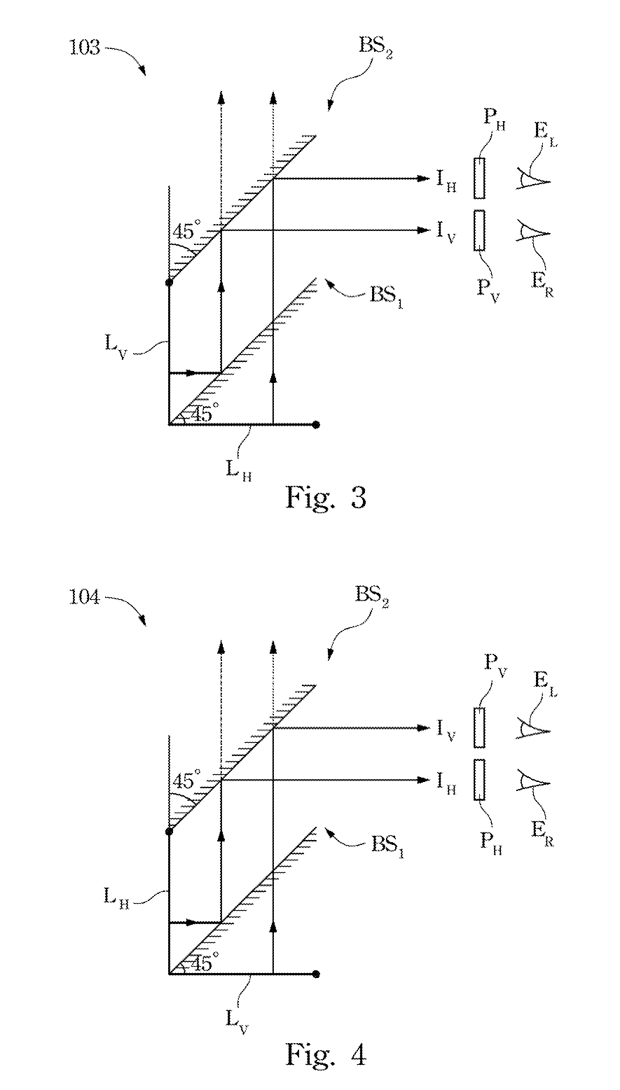

FIG. 4 illustrates a side view of a stereoscopic display system according to a fourth embodiment of this invention. The stereoscopic display system 104 is almost the same as the stereoscopic display system 103 except that the two displays L_{H}, L_{V} in the stereoscopic display system 104 are arranged in reverse positions relative to the stereoscopic display system 103. Therefore, the image I_{H} is serially reflected by the beam splitter BS₁ and beam splitter BS₂ before reaching a viewer's eyes E_{L}, E_{R}. The image I_{V} is passed through the beam splitter BS₁ and reflected by the beam splitter BS₂ before reaching the viewer's eyes E_{L}, E_{R}.

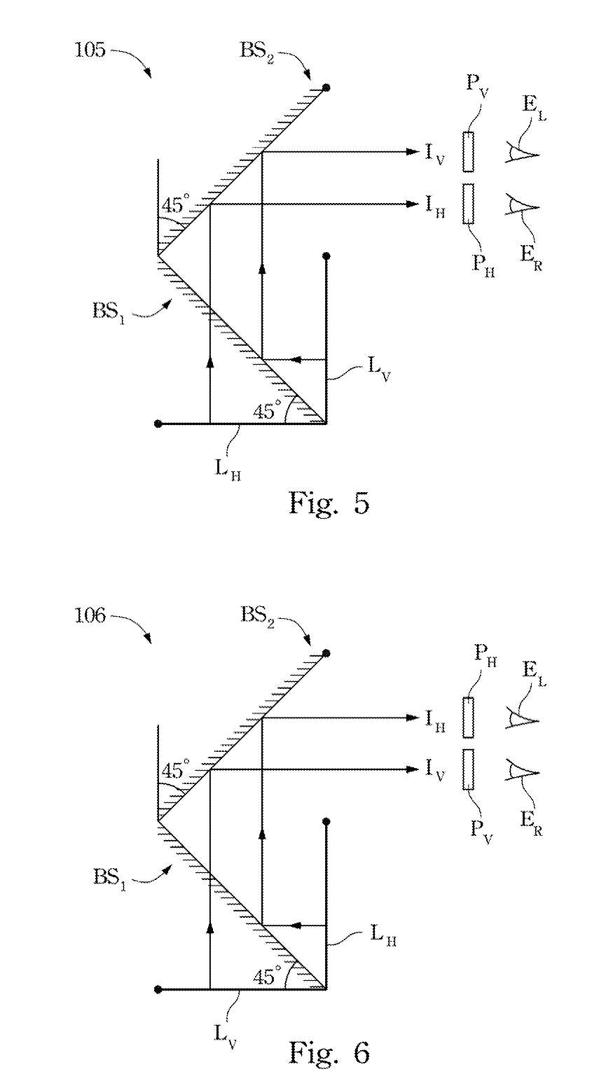

FIG. 5 illustrates a side view of a stereoscopic display system according to a fifth embodiment of this invention. The stereoscopic display system 105 basically includes two displays L_{H}, L_{V} and two beam splitters BS₁, BS₂. The two displays L_{H}, L_{V} respectively emit the right eye and left eye images, e.g. the display L_{H} emits the right eye image while the display L_{V} emits the left eye image, or the display L_{V} emits the right eye image while the display L_{H} emits the left eye image. The two displays L_{H}, L_{V} are arranged substantially perpendicular to each other. The beam splitter BS₁ is inclined at 45 degree to the display L_{H} and connected to an intersection of the two displays L_{H}, L_{V}. The beam splitter BS₂ is inclined at 45 degree to the display L_{V} and connected to an end of the beam splitter BS₁, which is opposite to the intersection of the beam splitter BS₁ and the two displays L_{H}, L_{V}. Besides, the beam splitter BS₁ is arranged substantially perpendicular to the beam splitter BS₂. The image I_{V} is serially reflected by the beam splitter BS₁ and beam splitter BS₂ before reaching a viewer's eyes E_{L}, E_{R}. The image I_{H} is passed through the beam splitter BS₁ and reflected by the beam splitter BS₂ before reaching the viewer's eyes E_{L}, E_{R}. Since the images I_{H} and I_{V} are reflected by different times, e.g. one time and two times, before reaching the viewer's eyes E_{L}, E_{R}, either the display L_{V} or L_{H} has to be reversed in displaying the image left to right, thereby providing a correct composite image. The viewer, who wears polarized 3D glasses P_{V}, P_{H} (one lens P_{V} is vertically polarized and the other one P_{H} is horizontally polarized), should be able to see a virtual right eye image in the right eye E_{R} and a virtual left eye image in the left eye E_{L}. The viewer's brain then receives the two different images and composites them into a virtual three-dimensional image.

FIG. 6 illustrates a side view of a stereoscopic display system according to a fourth embodiment of this invention. The stereoscopic display system 106 is almost the same as the stereoscopic display system 105 except that the two displays L_{H}, L_{V} in the stereoscopic display system 106 are arranged in reverse positions relative to the stereoscopic display system 105. Therefore, the image I_{H} is serially reflected by the beam splitter BS₁ and beam splitter BS₂ before reaching a viewer's eyes E_{L}, E_{R}. The image I_{V} is passed through the beam splitter BS₁ and reflected by the beam splitter BS₂ before reaching the viewer's eyes E_{L}, E_{R}.

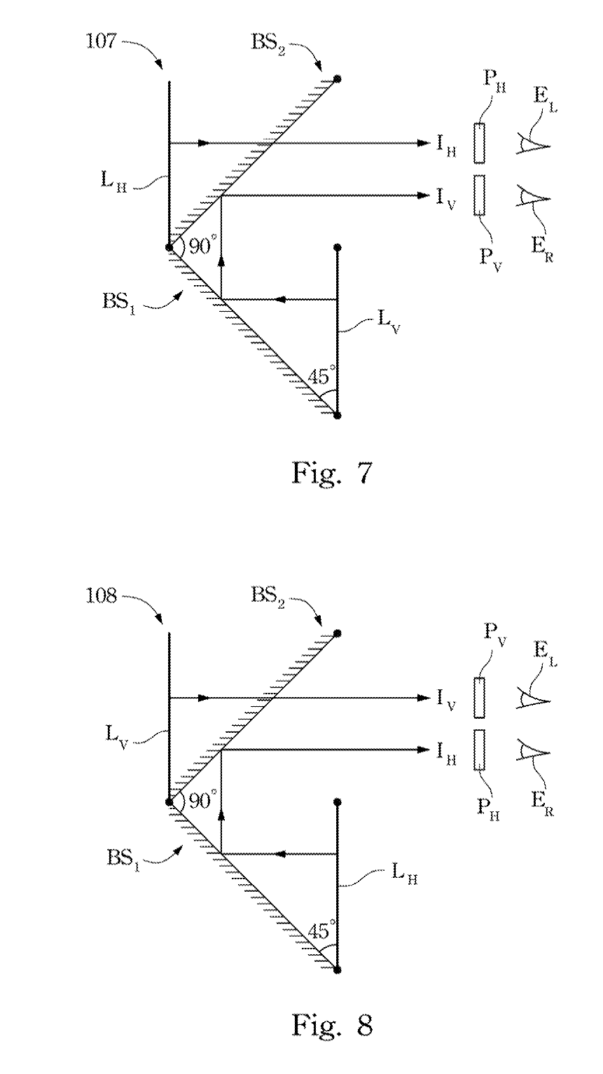

FIG. 7 illustrates a side view of a stereoscopic display system according to a seventh embodiment of this invention. The stereoscopic display system 107 basically includes two displays L_{H}, L_{V} and two beam splitters BS₁, BS₂. The two displays L_{V} respectively emit the right eye and left eye images, e.g. the display L_{H} emits the right eye image while the display L_{V} emits the left eye image, or the display L_{V} emits the right eye image while the display L_{H} emits the left eye image. The two displays L_{H}, L_{V} are in substantial parallel with each other. The beam splitter BS₁ is inclined at 45 degree to the display L_{H} and interconnected between the two displays L_{H}, L_{V}. The beam splitter BS₂ is inclined at 45 degree to the display Lᵥ and arranged substantially perpendicular to the beam splitter BS₁. Besides, the beam splitter BS₂ is connected to an intersection of the beam splitter BS₁ and the display L_{H}. The image I_{V} is serially reflected by the beam splitter BS₁ and beam splitter BS₂ before reaching a viewer's eyes E_{L}, E_{R}. The image I_{H} is passed through the beam splitter BS₂ before reaching the viewer's eyes E_{L}, E_{R}. Since the images I_{H} and I_{V} are reflected by different times, e.g. one time and two times, before reaching the viewer's eyes E_{L}, E_{R}, either the display L_{V} or L_{H} has to be reversed in displaying the image left to right, thereby providing a correct composite image. The viewer, who wears polarized 3D glasses P_{V}, P_{H} (one lens P_{V} is vertically polarized and the other one P_{H} is horizontally polarized), should be able to see a virtual right eye image in the right eye E_{R} and a virtual left eye image in the left eye E_{L}. The viewer's brain then receives the two different images and composites them into a virtual three-dimensional image.

FIG. 8 illustrates a side view of a stereoscopic display system according to an eighth embodiment of this invention. The stereoscopic display system 108 is almost the same as the stereoscopic display system 107 except that the two displays L_{H}, L_{V} in the stereoscopic display system 108 are arranged in reverse positions relative to the stereoscopic display system 107. Therefore, the image is serially reflected by the beam splitter BS₁ and beam splitter BS₂ before reaching a viewer's eyes E_{L}, E_{R}. The image I_{V} is passed through the beam splitter BS₂ before reaching the viewer's eyes E_{L}, E_{R}.

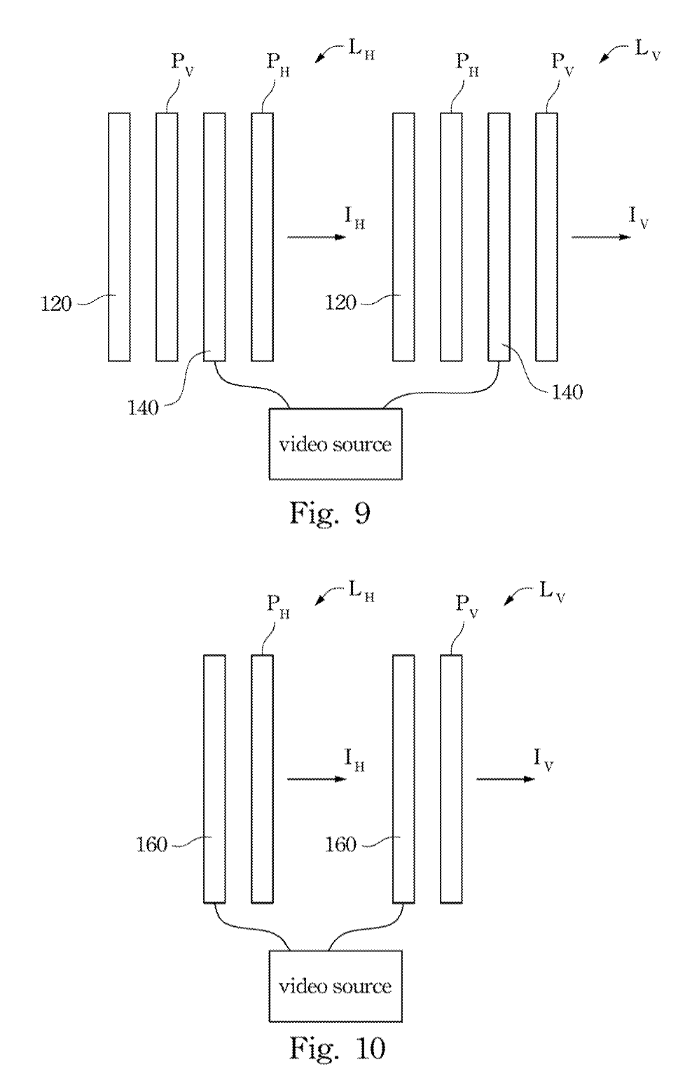

FIG. 9 illustrates an embodiment of the two displays L_{H}, L_{V} as illustrated in FIG. 1-FIG. 8. In this embodiment, the two displays L_{H}, L_{V} are two liquid crystal displays (LCDs) of two orthogonally polarized light sources. In particular, each display L_{H} or L_{V} includes a back light 120 and a liquid crystal panel 140, which is sandwiched between two polarizers P_{V} and P_{H}. The display L_{H} has its polarizer P_{H} in front of the liquid crystal panel 140 and its polarizer P_{V} behind the liquid crystal panel 140, thereby producing a horizontally polarized image I_{H}. The display L_{V} has its polarizer P_{V} in front of the liquid crystal panel 140 and its polarizer P_{H} behind the liquid crystal panel 140, thereby producing a vertically polarized image I_{V}. The differences between the two displays L_{H}, L_{V} are that the two polarizers P_{V} and P_{H} are reverse in their positions. A single video source outputs image signals to two respective liquid crystal panels 140. In an another embodiment, the two polarizers P_{V} and P_{H} can be two linearly polarized polarizers, which are orthogonally polarized to each other, but need not to be a vertically polarized one and a horizontally one. In another embodiment, the two polarizers P_{V} and P_{H} can be two circularly polarized polarizers, i.e. one polarizer is clockwise polarized and the other is counter-clockwise polarized. In still another embodiment, the two polarizers P_{V} and P_{H} can be two polarizers or filters that emit two different sets of red, blue and green frequencies (also referred as Dolby 3D) when a light source passes by.

FIG. 10 illustrates another embodiment of the display two displays L_{H}, L_{V} as illustrated in FIG. 1-FIG. 8. The display device 160 can be any display component other than LCD, such as organic light-emitting diode (OLED) displays, plasma display panels (PDP), cathode ray tube (CRT), light-emitting diode (LED) displays or a video projectors etc. In an another embodiment, the two polarizers P_{V} and P_{H} can be two linearly polarized polarizers, which are orthogonally polarized to each other, but need not to be a vertically polarized one and a horizontally one. In another embodiment, the two polarizers P_{V} and P_{H} can be two circularly polarized polarizers, i.e. one polarizer is clockwise polarized and the other is counter-clockwise polarized. In still another embodiment, the two polarizers P_{V} and P_{H} can be two polarizers or filters that emit two different sets of red, blue and green frequencies (also referred as Dolby 3D) when a light source passes by.

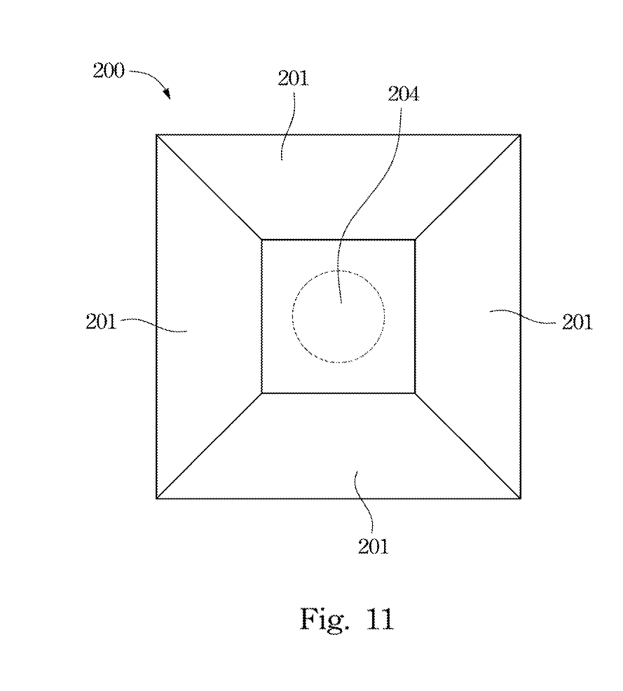

FIG. 11 illustrates a top view of a stereoscopic display system 200 including multiple display units. The stereoscopic display system 200 includes multiple display units 201, which can be either one of the above-mentioned stereoscopic display systems 101, 102, 103, 104, 105, 106, 107, 108. Multiple display units 201, e.g. four display units or more, are interconnected to form a convex regular polygon for providing images to the viewers around the convex regular polygon. The convex regular polygon can be an equilateral triangle, a square, a regular pentagon, regular hexagon or a convex regular polygon with even more edges. If each display units 201 of the display system 200 shows a respective part of a scenery, all the combined display units 201 can display a realistic 360 degree 3D view of the scenery. For example, if the display system 200 contains 6 display units interconnected to form a regular hexagon, each display unit should display a respective 60-degree view of the scenery. A motor 204 may be installed at a center of the convex regular polygon to rotate the convex regular polygon consisting of the display units 201.

In addition, the above mirror arrangement also works for a viewer wearing a pair of LCD shutter glasses. The lenses in the LCD shutter glasses darken and lighten in time with the refresh rate of the two displays L_{H}, L_{V}. The two displays L_{H}, L_{V} need not to be polarized. An IR emitter, RF emitter or other wireless device, installed in the two displays L_{H}, L_{V}, may sent out a synchronization signal which causes the LCD shutter glasses to darken over the right eye when the left eye image from the displays L_{V} is showing and then switch to darken the left eye when the right eye image from the displays L_{H} is showing. The two displays L_{H}, L_{V} will display right and left eye images respectively and alternatively according to the synchronization signal. Then the viewer's brain will receive the left and right eye images alternatively and combine them to create the 3D illusion.

According to the above-discussed embodiments, the stereoscopic display system equipped with two beam splitters and two displays would combine left eye and right eye images to create the effect like “an illusion of three-dimensional images in the air”. The viewers, who wear polarized glasses or LCD shutter glasses, are able to see the illusion of three-dimensional images.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A stereoscopic display system comprising:
a first display and a second display disposed substantially along a straight line for providing respective left eye and right eye images;
a first beam splitter inclined at 45 degree to the first display for reflecting either one of the left eye and right eye images towards a viewer; and
a second beam splitter inclined at 45 degree to the second display for reflecting the other one of the left eye and right eye images towards the viewer through the first beam splitter, wherein the first beam splitter is in substantial parallel with the second to beam splitter.

2. A stereoscopic display system comprising:
a first display and a second display disposed substantially perpendicular to each other for providing respective left eye and right eye images;
a first beam splitter inclined at 45 degree to the first display and connected to an intersection of the first and second displays; and
a second beam splitter inclined at 45 degree to the second display,
wherein either one of the left eye and right eye images is serially reflected by the first and second beam splitters before reaching a viewer, the other one of the left eye and right eye images is passed through the first beam splitter and reflected by the second beam splitter before reaching the viewer.

3. The stereoscopic display system of claim 2, wherein the second beam splitter is in substantial parallel with the first beam splitter and connected to an end of the second display, which is opposite to the intersection of the first and second displays.

4. The stereoscopic display system of claim 2, wherein the second beam splitter is disposed substantially perpendicular to the first beam splitter and connected to an end of the first beam splitter, which is opposite to the intersection of the first beam splitter and the first and second displays.

5. A stereoscopic display system comprising:
a plurality of display units interconnected to form a convex regular polygon for providing images to viewers around the convex regular polygon, wherein each display unit comprises:
a first display and a second display for providing respective left eye and right eye images; and
a first beam splitter inclined at 45 degree to the first display and a second beam splitter inclined at 45 degree to the second display for directing the left eye and right eye images towards a viewer.

6. The stereoscopic display system of claim 5, wherein the first and second displays are disposed substantially along a straight line, and the first beam splitter is in substantial parallel with the second beam splitter.

7. The stereoscopic display system of claim 5, wherein the first and second displays are disposed substantially perpendicular to each other, and the first beam splitter is connected to an intersection of the first and second displays.

8. The stereoscopic display system of claim 7, wherein the second beam splitter is in substantial parallel with the first beam splitter and connected to an end of the second display, which is opposite to the intersection of the first and second displays.

9. The stereoscopic display system of claim 7, wherein the first beam splitter is substantially perpendicular to the second beam splitter.

10. The stereoscopic display system of claim 5, wherein the first and second displays are disposed in substantial parallel with each other, the first beam splitter interconnected between the first and second displays, the second beam splitter is disposed substantially perpendicular to the first beam splitter.

11. The stereoscopic display system of claim 5, further comprising a motor, which is disposed at a center of the convex regular polygon, to rotate the convex regular polygon of the plurality of display units.
